(19) United States
(12) Patent Application Publication
(10) Pub. No.: US 2025/0155290 A1
(43) Pub. Date: May 15, 2025

(54) Systems and Methods for Performing Polarization Imaging

(71) Applicant: Vayu Robotics, Inc., Palo Alto, CA (US)

(72) Inventors: Anand Gopalan, Foster City, CA (US); Nitish Srivastava, Cupertino, CA (US); Mahesh Krishnamurthi, Saratoga, CA (US); Huaijin Chen, Belmont, CA (US); Rajanatha Shettigara, San Jose, CA (US); Jason Louis Ashton, Mountain View, CA (US); Adwait Jayant Gandhe, Santa Clara, CA (US); Hesam Rabeti, Palo Alto, CA (US); Vinaykumar Subrahmanya Hegde, San Jose, CA (US); Peter Jans Gillespie, Redwood City, CA (US); Arian Houshmand, Redwood City, CA (US)

(73) Assignee: Vayu Robotics, Inc., Palo Alto, CA (US)

(21) Appl. No.: 18/948,305

(22) Filed: Nov. 14, 2024

Related U.S. Application Data
(60) Provisional application No. 63/598,759, filed on Nov. 14, 2023.

(51) Int. Cl. G01J 4/02; H04N 23/55; H04N 23/67; H04N 23/80; H04N 25/705

(52) U.S. Cl. CPC G01J 4/02; H04N 23/55; H04N 23/672; H04N 25/705; H04N 23/80

(57) ABSTRACT

Systems and techniques for polarization are illustrated. One embodiment includes a system for polarization imaging. The system includes a camera that is an autofocus sensor. The camera includes a main lens. An aperture plane of the main lens is overlaid with a multiplexed polarization filter, where the multiplexed polarization filter includes a plurality of sub-filters; and each sub-filter follows a distinct polarization angle. The camera includes a detector array, wherein the detector array includes a plurality of sensor pixels. The camera includes a microlens array including a plurality of microlenses overlaid over the detector array. The microlens array is placed at a focal plane of the main lens. Each microlens is: unfiltered; and configured to direct incident light to a distinct subset of the sensor pixels. The system further includes a memory storing image data and a processor configured to execute instructions to process the image data.

### CROSS-REFERENCE TO RELATED APPLICATIONS

The current application claims the benefit of and priority under 35 U.S.C. § 119 (e) to U.S. Provisional Patent Application No. 63/598,759 filed Nov. 14, 2023, entitled “Systems and Methods for Performing Polarization Imaging”, the disclosure of which is incorporated herein by reference in its entirety for all purposes.

### FIELD OF THE INVENTION

The present invention generally relates to polarization imaging systems and methods of obtaining polarized images.

### BACKGROUND

Optical systems configured to capture images in three dimensions (e.g., “plenoptic cameras”) are one way to obtain depth maps to replicate and translate the perception of depth experienced through the binocular vision of human optics. Within the field of imaging, depth maps refer to images and other visual representations that contain information relating to the distance of the surfaces of objects and/or areas within an image. Depth maps will frequently determine these distances from the viewpoint of the original optical system.

In a normal camera, two-dimensional images are captured where each point (e.g., pixel sensor, film section) integrates all the rays of light that reach the point from any direction. Plenoptic cameras are capable of capturing information concerning light fields. Specifically, this is performed by placing a microlens array at the focal plane of the main lens of the camera. Each microlens directs light on a sub-array of pixels and the signals generated by the sub-array of pixels can be used to determine both intensity and direction information, which can enable the generation of images and depth maps.

### SUMMARY OF THE INVENTION

Systems and techniques for polarization are illustrated. One embodiment includes a system for polarization imaging. The system includes a camera that is an autofocus sensor. The camera includes a main lens. An aperture plane of the main lens is overlaid with a multiplexed polarization filter, where the multiplexed polarization filter includes a plurality of sub-filters; and each sub-filter of the plurality of sub-filters follows a distinct polarization angle. The camera includes a detector array, wherein the detector array includes a plurality of sensor pixels. The camera includes a microlens array including a plurality of microlenses overlaid over the detector array. The microlens array is placed at a focal plane of the main lens. Each microlens of the plurality of microlenses is: unfiltered; and configured to direct incident light to a distinct subset of the plurality of sensor pixels. The system includes a memory, wherein the memory stores: image data from the plurality of sensor pixels; and instructions for processing the image data. The system includes a processor configured to execute the instructions to process the image data.

In a further embodiment, processing the image data includes deriving, from the image data, a plurality of sub-aperture images; and each sub-aperture image of the plurality of sub-aperture images corresponds to a particular sub-filter of the plurality of sub-filters.

In a still further embodiment, the plurality of sub-aperture images includes a plurality of polarized views of a singular perspective of a scene. The singular perspective is captured by the camera in a single shot.

In a further embodiment, processing the image data further includes obtaining, from the plurality of polarized views, a set of depth cues for the singular perspective.

In still yet another embodiment, processing the image data further includes deriving, from the plurality of sub-aperture images, a new depth map for the scene; and/or updating, from the plurality of sub-aperture images, an existing depth map for the scene.

In a further embodiment, at least one of the new depth map or the existing depth map is applied to semantic scene segmentation.

In another embodiment, the distinct subset of the plurality of sensor pixels, that each microlens of the plurality of microlenses directs incident light to, includes a sensor pixel associated with each sub-filter of the plurality of sub-filters.

In a further embodiment, the sensor pixel associated with a given sub-filter of the plurality of sub-filters is sensitive to an orientation angle of the given sub-filter.

In another further embodiment, deriving, from the image data, a first sub-aperture image of the plurality of sub-aperture images includes for each microlens of the plurality of microlenses, locating a corresponding sensor pixel, of the distinct subset of the plurality of sensor pixels. The corresponding sensor pixel is associated with a first sub-filter of the plurality of sub-filters. Deriving the first sub-aperture image further includes digitally combining the image data of the corresponding sensor pixels associated with the first sub-filter into the first sub-aperture image.

In a further embodiment, for the first sub-aperture image, a relative position of each microlens in the microlens array is equivalent to a relative position of the corresponding sensor pixel associated with the first sub-filter in the first sub-aperture image.

In another embodiment, the main lens is a standard lens.

In another embodiment, the main lens is a specialty lens.

In another embodiment, the main lens is a lens stack including a plurality of lens elements.

In yet another embodiment, a first sub-filter, of the plurality of sub-filters, has a polarization orientation angle of 0°. A second sub-filter has a polarization orientation angle of 45°. A third sub-filter has a polarization orientation angle of 90°. A fourth sub-filter has a polarization orientation angle of 135°.

In another embodiment, the distinct subset of the plurality of sensor pixels follows a square grouping.

In a further embodiment, the square grouping is a 2×2 configuration of sensor pixels.

In another embodiment, the autofocus sensor is a phase-detection autofocus sensor.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The description and claims will be more fully understood with reference to the following figures and data graphs, which are presented as exemplary embodiments of the invention and should not be construed as a complete recitation of the scope of the invention.

FIGS. 1A-1C conceptually illustrate an optical image filtering scheme applied to lenses developed in accordance with various embodiments of the invention.

FIG. 2 illustrates a process for the conversion of raw image data into depth images, in accordance with certain embodiments of the invention.

FIG. 3 is a conceptual diagram of a polarization imaging system configured in accordance with some embodiments of the invention.

FIGS. 4A-4D illustrate various components of imaging sensors configured in accordance with some embodiments of the invention.

FIGS. 5A-8C illustrate images obtained using sensory mechanisms configured in accordance with a number of embodiments of the invention.

FIG. 9 conceptually illustrates a multi-sensor calibration setup in accordance with multiple embodiments of the invention.

### DETAILED DESCRIPTION

Turning now to the drawings, systems and methods for performing polarization imaging in accordance with various embodiments of the invention are illustrated. In many embodiments, polarization imaging systems capture polarization cues, which can be used to infer depth information. Polarization images can also provide information concerning light reflections that can be relevant to operations including (but not limited to) entity detection and/or correction of poor lighting.

Polarization imaging systems in accordance with several embodiments of the invention can perform single-shot acquisition of polarimetric measurements. In many embodiments, polarization images are produced using multiplexed optical polarization filtering at the aperture plane of a main lens. Such systems can be contrasted with division of focal plane (DoFP) techniques where microstructure polarization elements are integrated in an array set in a focal plane. As is discussed further below, placement of polarization filters at the aperture plane is used to perform multiplexed polarization filtering. A microlens array placed at the focal plane of the main lens can then direct light onto an array of sensor pixels. Subarrays of the array of sensor pixels may contain information regarding light rays having specific polarizations. Additionally or alternatively, the sensor pixels may be normal photodiodes (e.g., without polarization sensitivity). In this way, computational techniques can be used to form multiple images that each correspond to an image of the scene from the same viewpoint, but captured with different polarizations. As polarization information includes depth cues, the set of images can be utilized to infer distances to the surfaces of objects visible within the scene. The ability to capture multiple images having different polarizations from a single viewpoint can eliminate artifacts due to disparities that can occur when multiple separate cameras are utilized to obtain a set of images of a scene having different polarizations. Furthermore, polarization imaging systems in accordance with various embodiments of the invention can be constructed using image sensors manufactured for use in conventional cameras (e.g. mass-produced phase-detection autofocus sensors).

Polarization imaging systems in accordance with various embodiments of the invention can be incorporated within sensor platforms in combination with any of a variety of sensors. In various embodiments, sensors including (but not limited to) laser imaging, detection, and ranging (LiDAR) systems and/or conventional cameras may be utilized in combination with a polarization imaging system to gather information concerning the surrounding environment.

In a number of embodiments, self-supervised calibration of a polarization imaging system and/or other sensors incorporated within a sensor platform can be performed using feature detection and optimization. In certain embodiments, the sensor(s) can be periodically maintained using self-supervised calibration. Polarization imaging systems and methods for performing polarization imaging and polarimetric measurements in accordance with various embodiments of the invention are discussed further below.

### A. Polarization Imaging

Images that capture information concerning the polarization angles of incident light provide depth cues that can be used to recover highly reliable depth information. Polarization imaging systems and methods of capturing polarization images in accordance with many embodiments of the invention are capable of performing single-shot, single-camera polarization imaging. Furthermore, systems configured in accordance with numerous embodiments of the invention may be based on mass-produced phase-detection-based autofocus sensors.

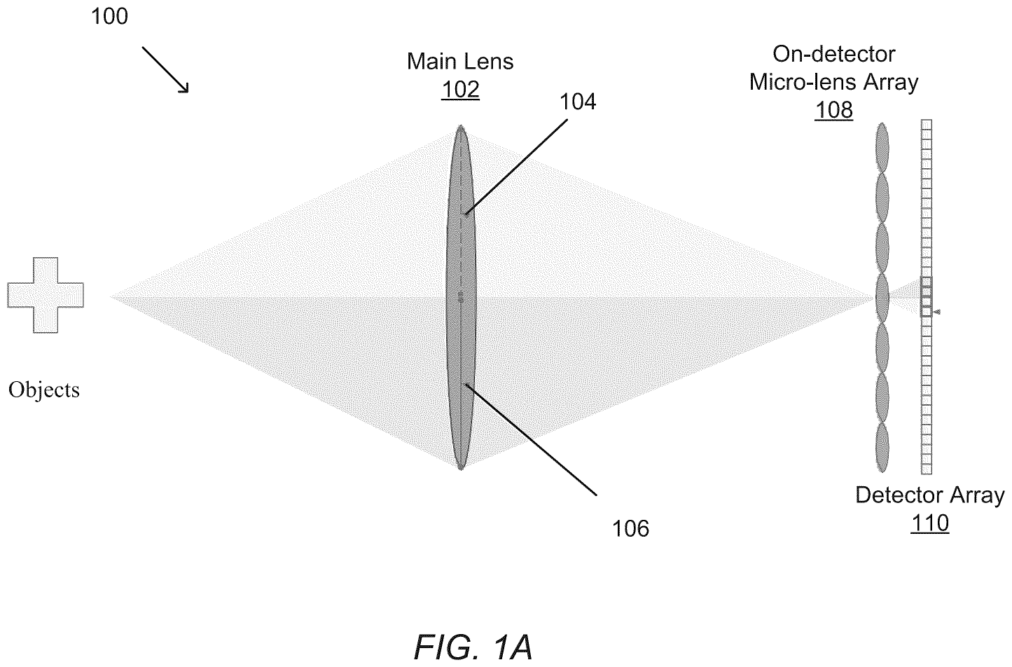

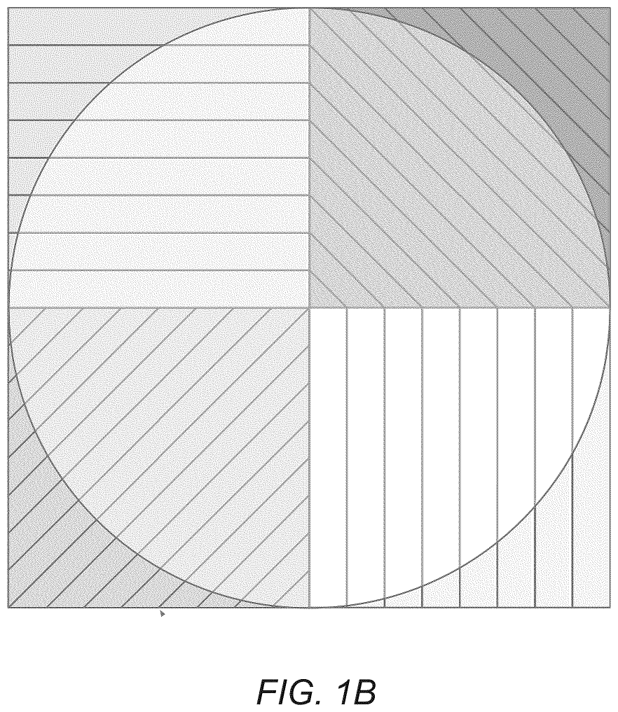

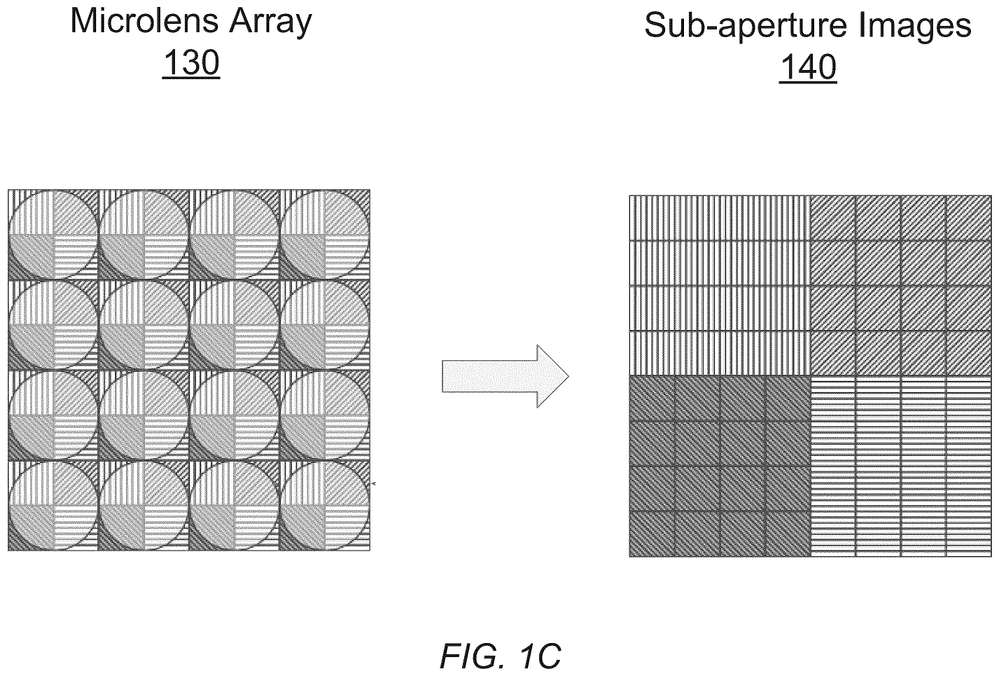

An optical image filtering scheme configured in accordance with various embodiments of the invention are conceptually illustrated in FIGS. 1A-1C. The filtering schemes (represented in FIG. 1A) may be implemented using polarization imaging systems made up of one or more image sensors. These image sensors may include but are not limited to phase-detection autofocus sensors. The image sensors may each combine a polarization filter located at an aperture plane of a main lens (expanded in FIG. 1B) with a microlens array (expanded in FIG. 1C) located at the focal plane of a main lens. FIG. 1A illustrates a side view of an image sensor 100 in accordance with an embodiment of the invention that utilizes a “main” lens 102 and a polarization filter located at an aperture plane of the main lens. In performing multiplexed polarization filtering, the aperture plane of the main lens 102 can be divided into different areas, each covered with an individual sub-aperture area 104, 106 of the polarization filter (also referred to as “sub-filters” in this disclosure). In accordance with some embodiments, polarization sub-filters may be aligned at different angles, thereby letting light, from specific directions, into the microlenses. The example disclosed in FIG. 1A filters a first subset of the rays incident on the main lens 102 based upon a first sub-aperture area 104 with a first polarization and filters a second subset based upon a second sub-aperture area 106 with a second polarization. Though the aperture plane of the main lens 102 disclosed in FIG. 1A only shows a polarization filter incorporating two sub-filters in accordance with various embodiments of the invention, polarization filters may account for various different polarizations (as shown in FIGS. 1B and 1C) including but not limited to 2, 4, 8, and 16 sub-aperture areas. Polarization sub-filters may, additionally or alternatively have any polarization angle measurements including but not limited to 0°, 45°, 90°, and 135°.

An array 108 of microlenses can be located at the focal plane of the main lens so that the main lens focuses light polarized by the polarization filter(s) onto the microlens array 108. In accordance with various embodiments of the invention, each microlens may be unfiltered. As illustrated in FIG. 1A, each microlens may be used to reflect subsets of polarized light to a detector array 110. The detector arrays 110 may be used to convert the respective subsets of polarized lights to distinct (e.g., 2D) sub-aperture images. Using systems in accordance with several embodiments of the inventions, detector arrays 110 may include, but are not limited to normal, non-polarization-sensitive sensor pixels, wherein each microlens corresponds to a small subset of the sensor pixels. Specifically, each microlens of the microlens array 108 directs subsets of light, incident from a given angle, towards a corresponding subset of the detector array 110 (where the subset represents a shared polarization angle). In doing so, the detector array 110 may produce sub-aperture images, wherein each image corresponds to a specific sub-filter (and sub-aperture area of the main lens).

A frontal view of a main lens, where different polarization sub-filters are applied to different regions within an aperture plane, in accordance with an embodiment of the invention is illustrated in FIG. 1B. FIG. 1B depicts the aperture plane of a main lens divided into four areas, each with a different polarization sub-filter. Main lenses may correspond to multiple types of camera lenses including but not limited to standard lenses and/or specialty lenses. While the main lens of FIGS. 1A and 1B are shown as singular lenses, a main lens can be a lens stack including multiple lens elements. Moreover, as can readily be appreciated, polarization filters in accordance with various embodiments of the invention can be located at any aperture plane appropriate to the requirements of specific applications. Light rays coming from individual points may initially arrive at the main lens, experience multiplexed polarization filtering, and/or travel through the aperture plane of the main lens with multiplexed polarization filtering applied.

A frontal view of a microlens array and a resulting sub-aperture image, generated in accordance with an embodiment of the invention is illustrated in FIG. 1C. In accordance with certain embodiments, microlenses may cover small neighborhoods of four or more pixels on detector arrays. Individual sensors used in detector arrays in accordance with numerous embodiments of the invention may correspond to neighborhoods of pixels including but not limited to, square pixels, rectangular pixels, and/or other non-square pixel arrangements. For example, FIG. 1C depicts a microlens array 130 including microlenses overlaid on two-by-two groupings of square pixels. Using the above system, the microlenses serve to demultiplex polarized rays into distinct neighborhoods (of detector array pixels), such that rays with different polarizations have been projected to corresponding pixels in an individual neighborhood. Systems operating in accordance with various embodiments of the invention can then use computational techniques (including but not limited to techniques discussed further below) to recover the (polarized) sub-aperture images 140 that each correspond to an image of a singular scene at different polarization angles. By utilizing a (multiplexed) polarization filter and demultiplexing the polarized light using a microlens array 130, polarized imaging systems in accordance with many embodiments of the invention are capable of capturing multiple images of a scene at different polarization angles in a single shot using an image sensor with a singular polarization filter applied to a single aperture.

In accordance with many embodiments of the invention, image data may be captured by polarization imaging systems including one or more sensors similar to any of the sensors described above may be utilized to generate data including but not limited to distance information, localization information, mapping information and/or depth maps.

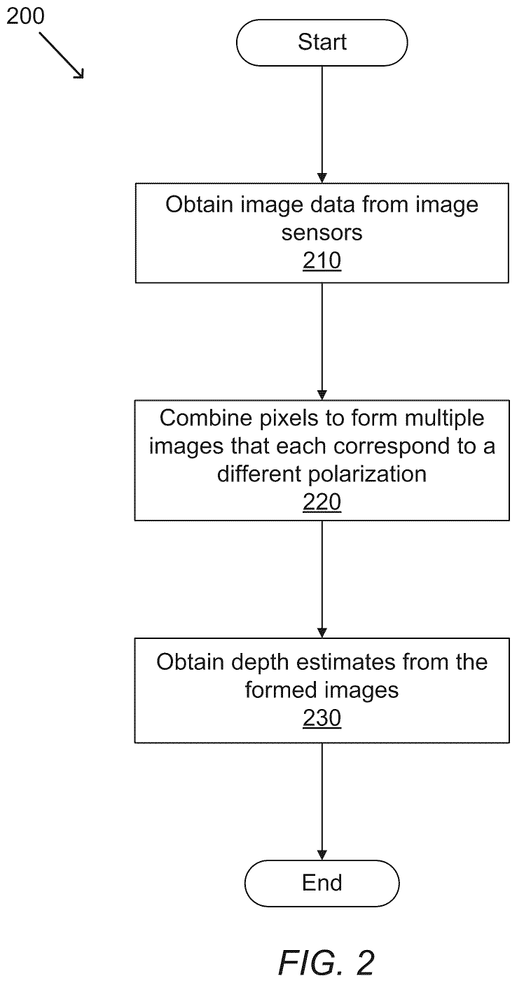

An example of a process, through which raw image data captured using an imaging system that incorporates at least one multiplexed polarization filter can be utilized to generate one or more depth images in accordance with numerous embodiments of the invention is illustrated in FIG. 2. Process 200 obtains (210) image data captured by pixels from an image sensor. As indicated above, polarization imaging systems configured in accordance with certain embodiments of the invention can include groups of pixels that each correspond to an individual microlens. When multiplexed polarization filtering is employed, multiple sub-aperture images can be obtained that each correspond to a different polarization orientation. In many embodiments, the multiple images are obtained by combining (220) information from subsets of the groups of pixels.

As noted above, polarization information can provide depth cues which can be utilized to obtain (230) depth information (e.g. a depth map). In many embodiments, depth information can be derived from polarization cues. In several embodiments, depth cues derived from the polarization information can be used to refine a coarse depth map provided as an input to the process 200. As can readily be appreciated, the specific manner in which depth cues identified using the set of multiple images that each correspond to a different polarization are utilized to obtain depth information are largely dependent upon the requirements of specific applications.

While specific processes for generating depth information and/or depth maps using image data captured using multiplexed polarization filters are described above with reference to FIG. 2, any of a variety of polarized imaging systems can be utilized within localization systems to capture polarization depth cues as appropriate to the requirements of specific applications in accordance with various embodiments of the invention. For example, the systems described above utilize image sensors (e.g., detector arrays) with pixels that are non-polarization sensitive. However, in some embodiments of the invention, image sensors can be utilized in which each pixel in a pixel neighborhood is sensitive to a particular polarization orientation angle. Systems and methods for processing images captured using multiplexed polarization filters in accordance with numerous embodiments of the invention are discussed further below.

Furthermore, systems and methods in accordance with a number of embodiments of the invention are not limited to the specific configurations described above with reference to FIGS. 1A-2. Accordingly, it should be appreciated that the processes described herein can also be implemented outside the context of the imaging systems described above with reference to FIGS. 1A-1C. Various systems and methods for implementing localization systems and applications in accordance with numerous embodiments of the invention are discussed further below.

### B. Polarization Imaging Systems

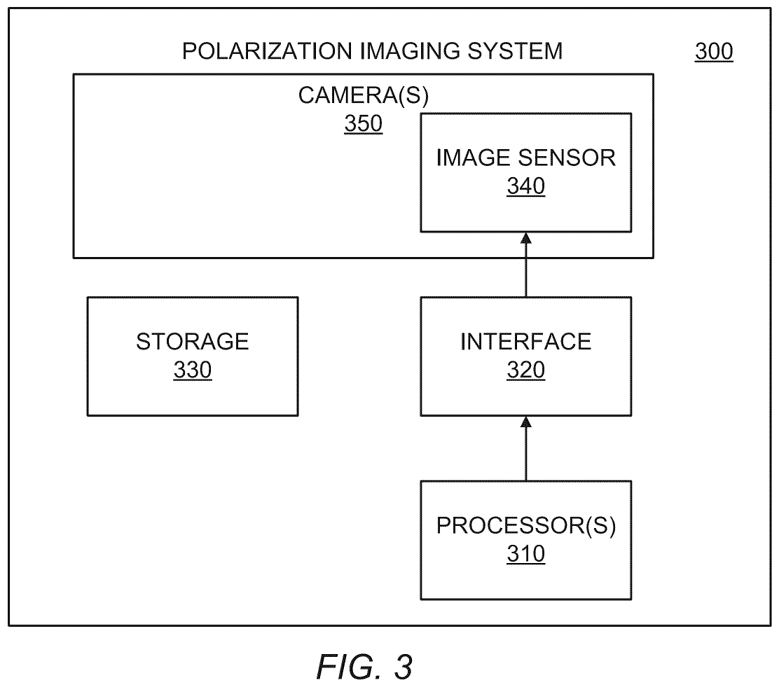

Polarization imaging systems may be utilized in a variety of applications including but not limited to image-based localization. A conceptual diagram of a polarization imaging system in accordance with an embodiment of the invention is illustrated in FIG. 3. The polarization imaging system 300 includes (but is not limited to) one or more processors 310, such as a central processing unit CPU and/or a graphics processing unit (GPU); a data storage 320 component; an interface 330 component, and one or more cameras 340 and/or imaging instruments.

Hardware-based processors 310 may be implemented within polarization imaging systems and other devices operating in accordance with various embodiments of the invention to execute program instructions and/or software, causing computers to perform various methods and/or tasks, including the techniques described herein. Several functions including but not limited to data processing, data collection, machine learning operations, and/or simulation generation can be implemented on singular processors, on multiple cores of singular computers, and/or distributed across multiple processors.

Processors 310 may take various forms including but not limited to CPUs, digital signal processors (DSP), core processors within Application Specific Integrated Circuits (ASIC), image signal processors, and/or GPUs for the manipulation of computer graphics and image processing. Processors 310 may be directed to various polarization and/or localization operations. Processors may be coupled to at least one interface 330 component including but not limited to Display Serial Interfaces following Mobile Industry Processor Interface Protocols (MIPI DSIs). Additionally or alternatively, interfaces 330 may take the form of one or more wireless interfaces and/or one or more wired interfaces. In accordance with many embodiments of the invention, interfaces may be used to communicate with other devices and/or components including but not limited to the image sensors 350 of cameras 340. As indicated above, Processors 310 may, additionally or alternatively, be coupled with one or more GPUs. GPUs may be directed towards, but are not limited to ongoing perception, sensory, and/or calibration efforts.

Processors 310 implemented in accordance with numerous embodiments of the invention may be configured to process input data (e.g., image data) according to instructions stored in data storage 320 components. Data storage 320 components may include but are not limited to hard disk drives, nonvolatile memory, and/or other non-transient storage devices. Data storage 320 components, including but not limited to memory, can be loaded with software code that is executable by processors 310 to achieve certain functions. Memory may exist in the form of tangible, non-transitory, computer-readable mediums configured to store instructions that are executable by the processor 310. These instructions may be used to perform various processes implemented in accordance with several embodiments of the invention Data storage 320 components may be further configured to store supplementary information including but not limited to sensory, imaging, and/or depth map data.

Systems configured in accordance with a number of embodiments may include various additional input-output (I/O) elements, including but not limited to parallel and/or serial ports, USB, Ethernet, and other ports and/or communication interfaces capable of connecting systems to external devices and components. Ethernet network switches configured in accordance with several embodiments of the invention may connect devices including but not limited to, computing devices, Wi-Fi access points, Wi-Fi and Long-Term Evolution (LTE) antennae, and servers in Ethernet local area networks (LANs) to maintain ongoing communication.

Polarization imaging systems may include one or more peripheral mechanisms (peripherals). Peripherals may include any of a variety of components for capturing data, including but not limited to cameras 340 and/or other sensors. In a variety of embodiments, cameras 340 and/or other sensors can be used to gather input images and/or provide output data maps. Additional sensors that may be used by polarization imaging systems configured in accordance with some embodiments may include but are not limited to ultrasonic sensors, motion sensors, light sensors, infrared sensors, and/or custom sensors. Additionally or alternatively, cameras 340 integrated in accordance with several embodiments of the invention may possess one or more image sensors 350. The one or more image sensors 350 may be connected to the processor(s) 310 through the interfaces 330 as described above.

Polarization imaging systems can utilize additional interfaces targeted to operations including but not limited to transmitting and receiving data over networks based on the instructions performed by processors 310, and application of the polarized images to greater configurations. For example, additional interfaces configured in accordance with many embodiments of the invention can be used to integrate polarization imaging systems into greater configurations that may be applied to localizing entities. The aforementioned localizing configurations may be referred to as localization systems in this application.

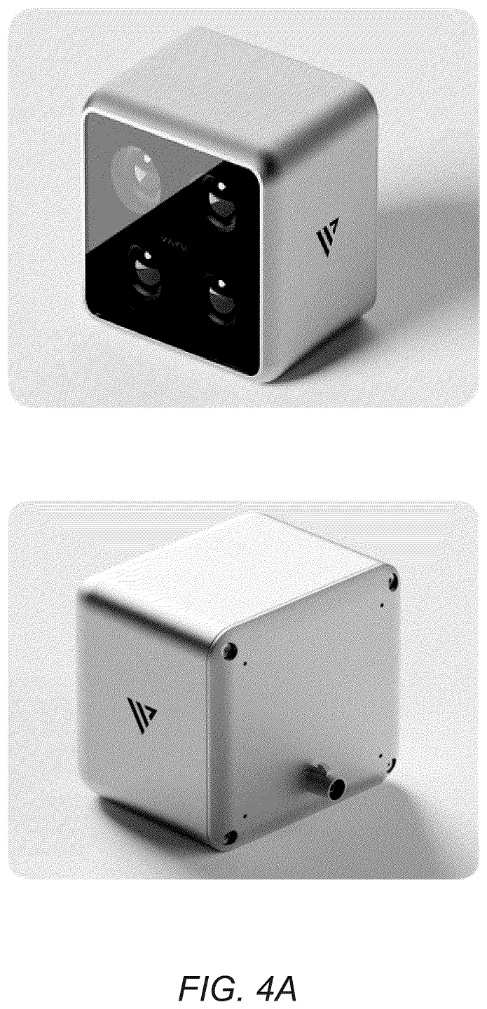

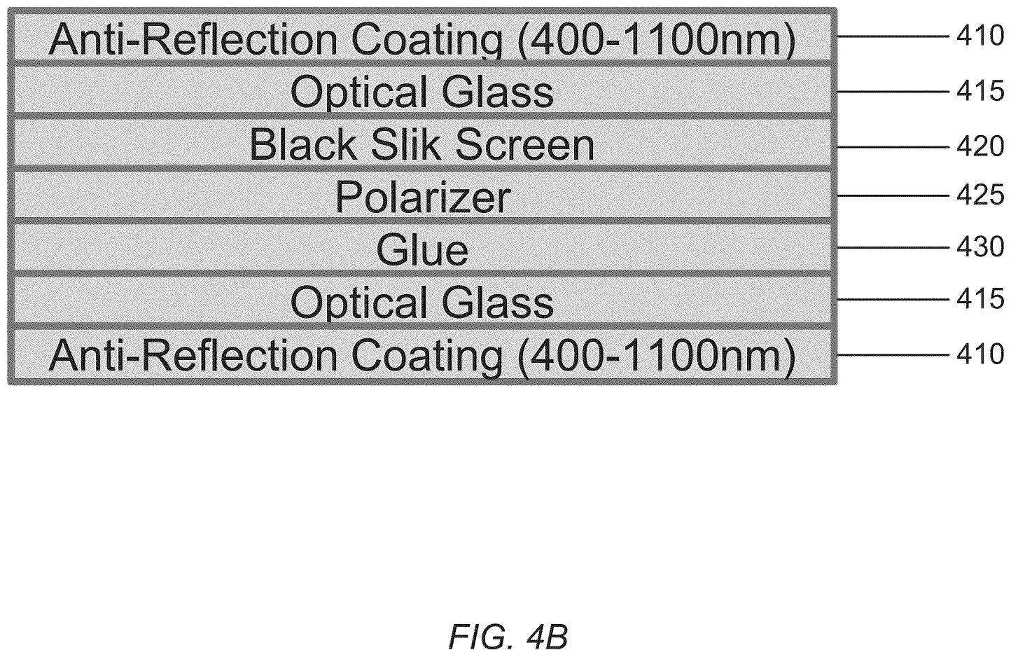

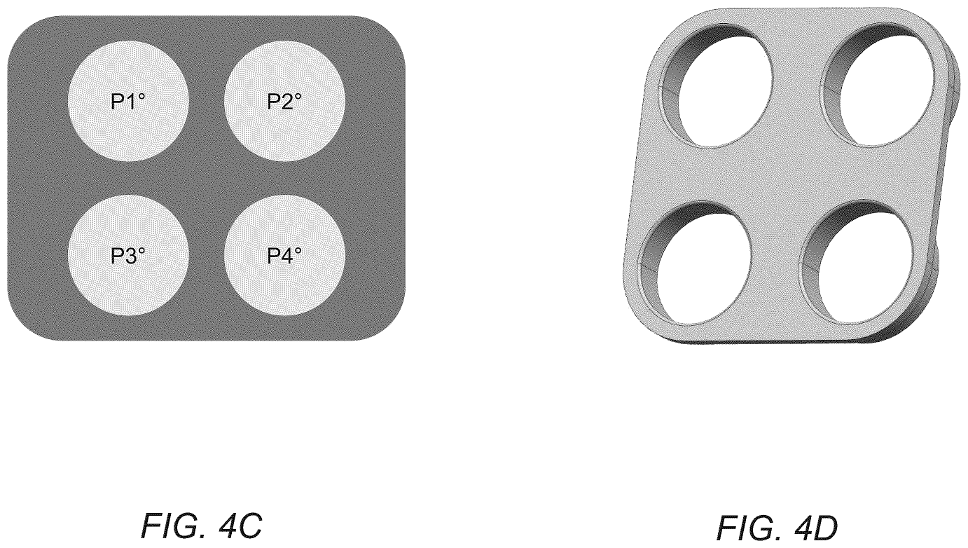

Examples of (imaging) sensors and associated components, operating in accordance with multiple embodiments of the invention, are illustrated in FIGS. 4A-4D. FIG. 4A illustrates multiple perspectives of an example image sensor; however, a variety of sensors (applied to a variety of purposes) can used by polarization imaging systems implemented in accordance with various embodiments of the invention. In doing so, polarization imaging systems are capable of performing (e.g., single-shot, single-camera) polarization imaging. Furthermore, systems configured in accordance with numerous embodiments of the invention may be based on mass-produced sensors. In many embodiments, systems utilizing one or more of cameras, time of flight cameras, structured illumination, light detection and ranging systems (LiDARs), laser range finders and/or proximity sensors can be utilized to acquire depth information (used to refer to information regarding the distance of a point or object). In many embodiments, multiple cameras (including but not limited to the cameras depicted in FIG. 4A) can be utilized to perform depth sensing by measuring parallax observable when images of the same scene are captured from different viewpoints. In certain embodiments, cameras that include polarized filters can be utilized to enable the capture of polarization depth cues.

FIG. 4B illustrates a cover glass configuration implemented for polarization filters implemented in accordance with multiple embodiments of the invention. The cover glass implemented for polarizer filters 425 may include, but is not limited to anti-reflection coating 410, optical glass 415, a black silk screen 420, and adhesive. In accordance with certain embodiments, the thickness of the total cover glass may be 4 mm with tolerance of +0 mm and −0.2 mm. In accordance with a number of embodiments, anti-reflection coating 410 may be used for the outermost layer of both sides of the cover glass. The anti-reflection coating 410 may, in certain embodiments, be anywhere from 400 nm-1100 nm thick. One layer inward from the anti-reflection coating 410, both sides of the cover glass may include optical glass 415. In accordance with several embodiments, the optical glass 415 used may include, but is not limited to BK7 glass. One layer inward from the optical glass 415, at least one side of the cover glass may incorporate a black silk screen 420. Additionally or alternatively, one layer after the optical glass 415, at least one side of the cover glass may incorporate an adhesive (e.g., lens glue 430). At the innermost layer, lenses configured in accordance with some embodiments may have the polarizer filter 425.

While specific layers, orderings of layers, and/or thicknesses of layers for polarizer configurations are described above, systems and methods in accordance with various embodiments of the invention can incorporate any arrangement of layers having any of a variety of thicknesses and/or materials as appropriate to the requirements of specific applications. As such, in certain embodiments, the layers of the polarizer may follow any order and/or sequence, and are not limited to the order and sequence shown and described.

Cover glass configurations in accordance with multiple embodiments of the invention are illustrated in FIGS. 4C and 4D. Polarizers may have apertures (P1°, P2°, P3°, P4°) arranged in the cover glass 2×2. In some embodiments, any two orthogonal apertures may be 29.0 mm+0.05 mm apart center-to-center. In accordance with a few embodiments, the cover glass apertures may each have a diameter of 19.3 mm+0.2 mm. The cover glass, as shown in FIG. 4C, may take the form of rounded rectangles. In such cases, the dimensions may be (60.9 mm+0.1 mm)×(67.9 mm+0.1 mm). Additionally or alternatively, the cover glass may take various other forms including but not limited to rectangular and oval. The cap for the cover glass, as shown in FIG. 4C, may have lens shrouds (that can also be arranged 2×2), wherein each lens shroud may have a diameter of 19.55 mm+0.05 mm. Finally, in accordance with many embodiments of the invention, the main lens(es) on which the cover glass is placed may have an outer diameter of 18.5 mm+0.1 mm.

While specific polarization imaging systems and sensor configurations are described above with reference to FIGS. 3-4D, any of a variety of polarization imaging systems and/or sensor configurations can be implemented as appropriate to the requirements of specific applications in accordance with various embodiments of the invention. Furthermore, applications and methods in accordance with various embodiments of the invention are not limited to use within any specific polarization imaging systems. Accordingly, it should be appreciated that the system configuration described herein can also be implemented outside the context of a polarization imaging system described above with reference to FIG. 3. Many systems and methods for performing polarization and/or localization in accordance with numerous embodiments of the invention are discussed further below.

### C. Localization Systems

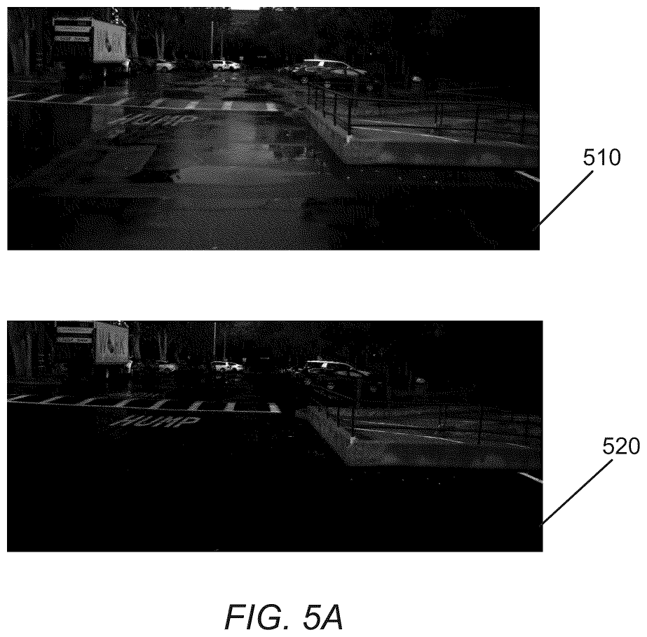

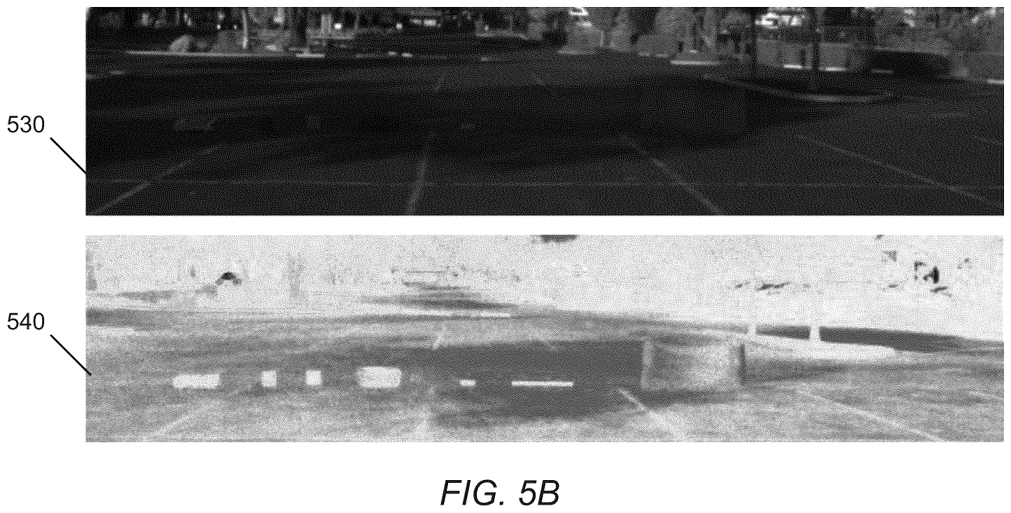

The benefits of using polarization imaging may include, but is not limited to the ability to generate high-quality depth maps as is evident in FIGS. 5A-8C. Polarization information can be helpful in machine vision applications for detecting the presence of transparent objects, avoiding confusion resulting from reflections, and analyzing high dynamic scenes. Referring first to FIG. 5A, the first image 510 shows the challenges that can be presented in machine vision applications by reflective surfaces such as wet roads. The second image 520 demonstrates how imaging using polarization filters can enable the elimination of reflections. Referring now to FIG. 5B, the challenges of interpreting an image 540 of a high dynamic scene containing objects that are in shadow can be appreciated. Specifically, an updated image 550 (of the same scene) generated using a polarization imaging system implemented in accordance with several embodiments of the invention reflects a drastic improvement in object identification. The updated image 550 shows how clearly objects can be discerned in high dynamic range images using polarization information. Polarization imaging systems in accordance with various embodiments of the invention may achieve this improvement by directly extracting the shapes of the objects in question by interrogating other properties (including but not limited to polarization) of the received light. This provides a much stronger signal than other imaging systems such as those relying only on received intensity and/or LiDAR's measured depth. Potential applications of polarization, including uses for performing segmentation and/or semantic analysis, are disclosed in U.S. Provisional patent application Ser. No. 18/416,820, entitled “Systems and Methods for Performing Autonomous Navigation,” filed Jan. 18, 2024, the disclosure of which, specifically the portions directed to image sensor configurations, is hereby incorporated by reference in its entirety for all purposes.

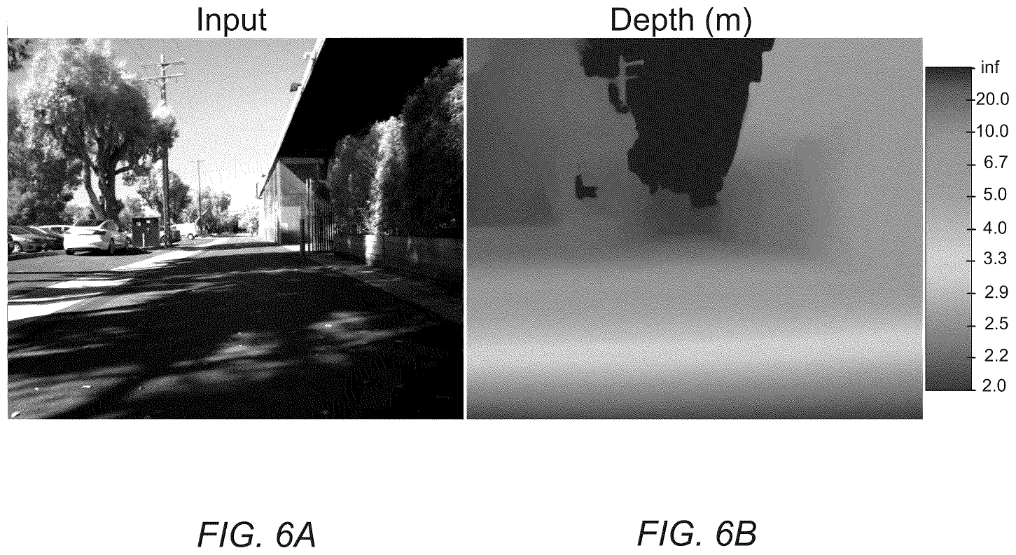

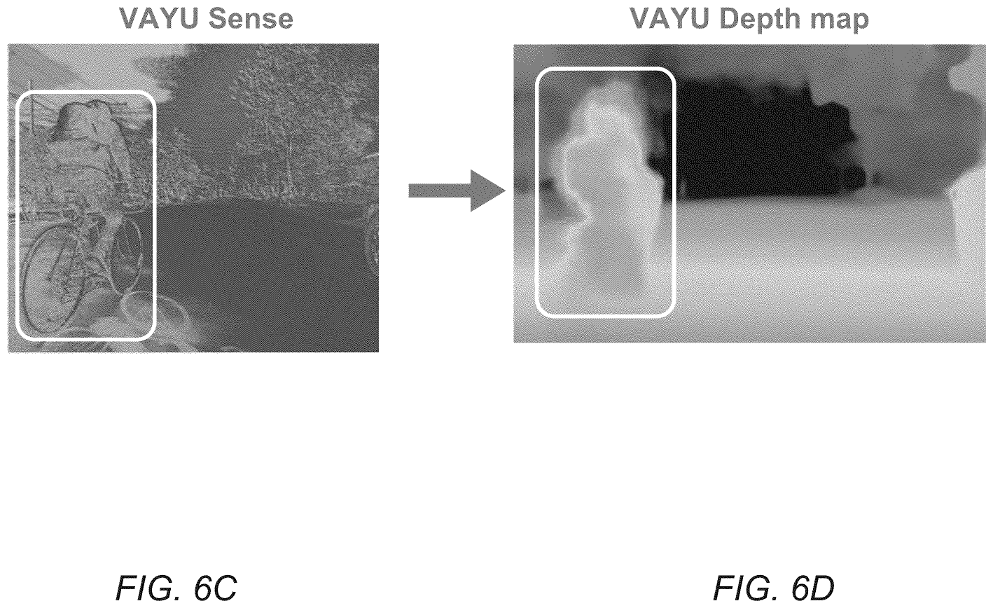

The benefits of using polarization imaging systems in the generation of depth maps can be readily appreciated with reference to FIGS. 6A-6D. FIGS. 6A and 6B show an image of a scene and a corresponding depth map generated using a polarization imaging system similar to the polarization imaging systems described herein. Specifically, the estimated depths of features in the image of FIG. 6A, depicting a parking lot behind a building, are illustrated in the depth map of FIG. 6B. FIG. 6B uses a color-based spectrum to illustrate these depths, where close features (e.g., 2 meters from the sensor) are represented by the color red and features with indeterminate/infinite depth (e.g., the sky) are represented by the color indigo. FIGS. 6C and 6D show how polarization information can be utilized to generate high-resolution depth maps that can then be utilized to perform segmentation and/or semantic analysis. Specifically, using polarized imaging system outputs including but not limited to that depicted in FIG. 5B, corresponding depth maps may be generated.

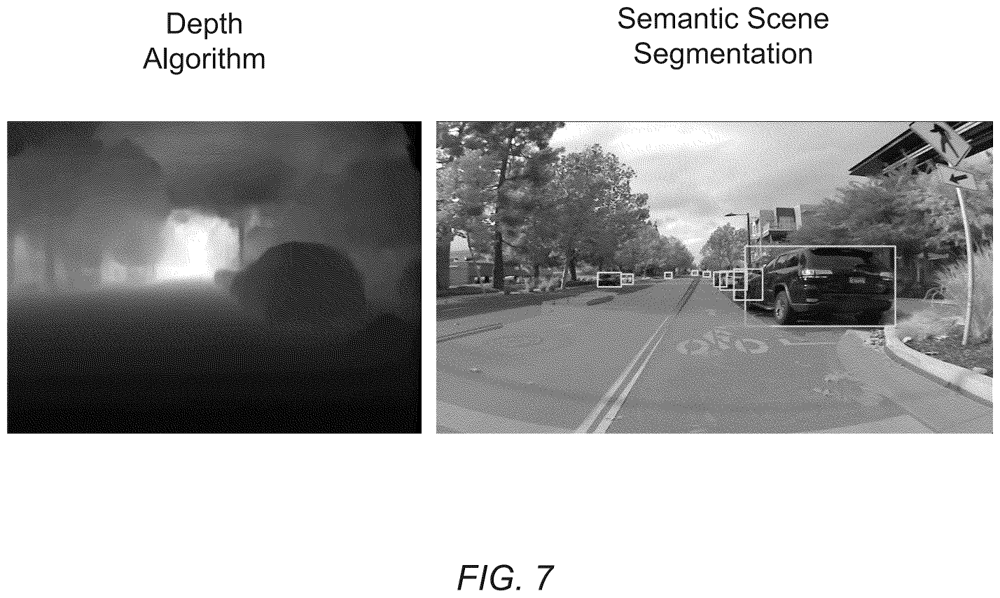

FIG. 7 expands on the above concept to show how depth maps may be used for purposes including but not limited to semantic scene segmentation (a computer vision task that involves dividing image(s) into different regions/classifications based on detected objects). In accordance with many embodiments, depth maps may (additionally or alternatively) be utilized to perform segmentation and/or semantic analysis. For example, depth maps may provide new channels of information (i.e., “depth channels”), which may be used in combination with standard channels. Standard channels may include, but are not limited to red, green, and blue color channels. Depth channels may reflect the inferred depth of given pixels relative to the camera(s). As such, in accordance with some embodiments, each pixel of an input RGB image may have four channels, including inferred pixel depth. Pixel depth may be used in segmentation and/or semantic analysis in scenarios including but not limited to determinations of whether particular pixels in three-dimensional space are occupied and extrapolating such determinations to use in avoidance and/or planning algorithms.

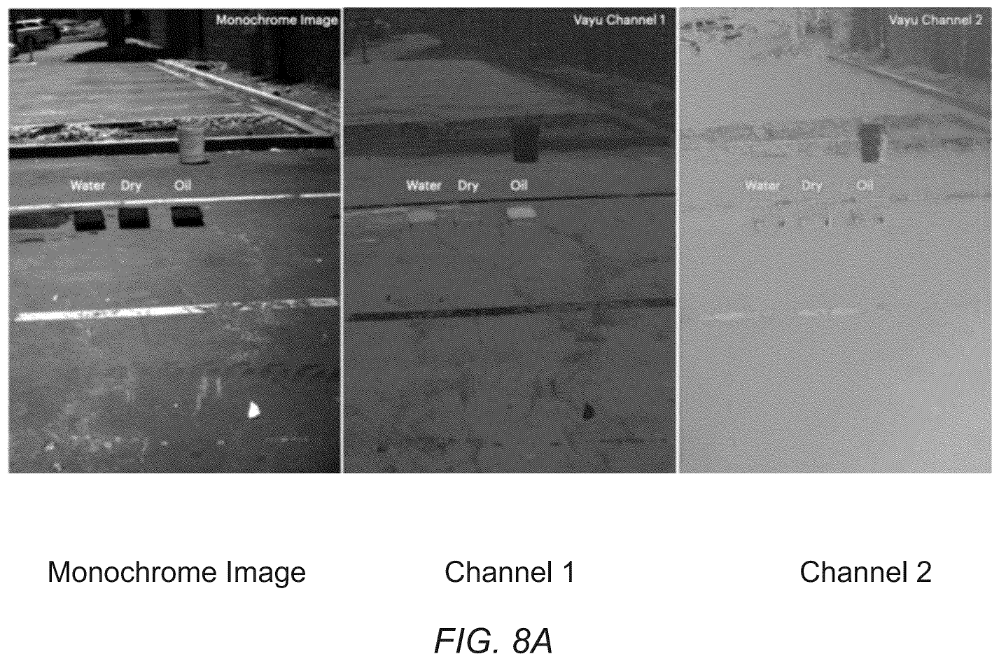

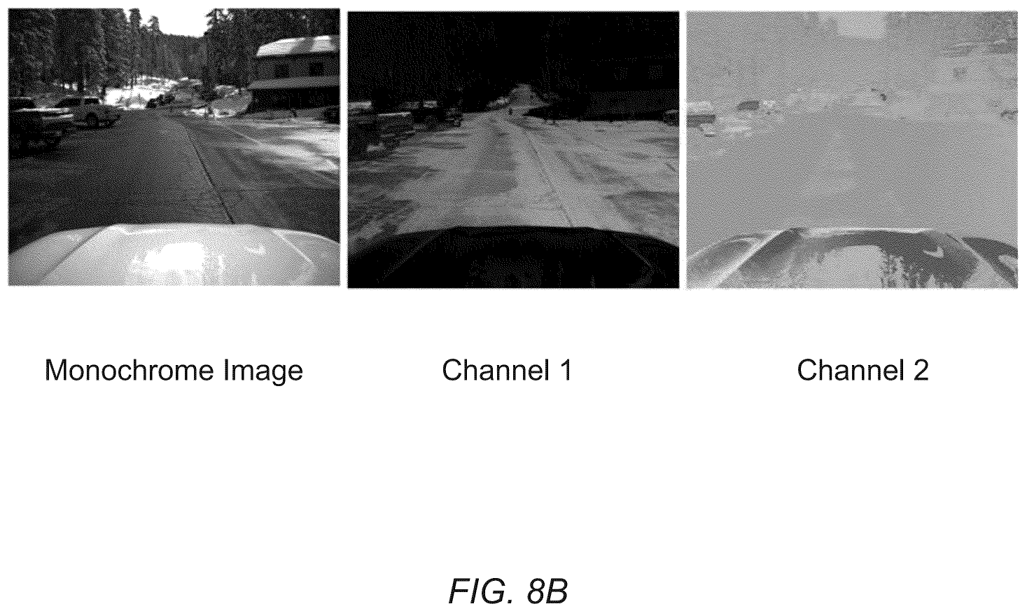

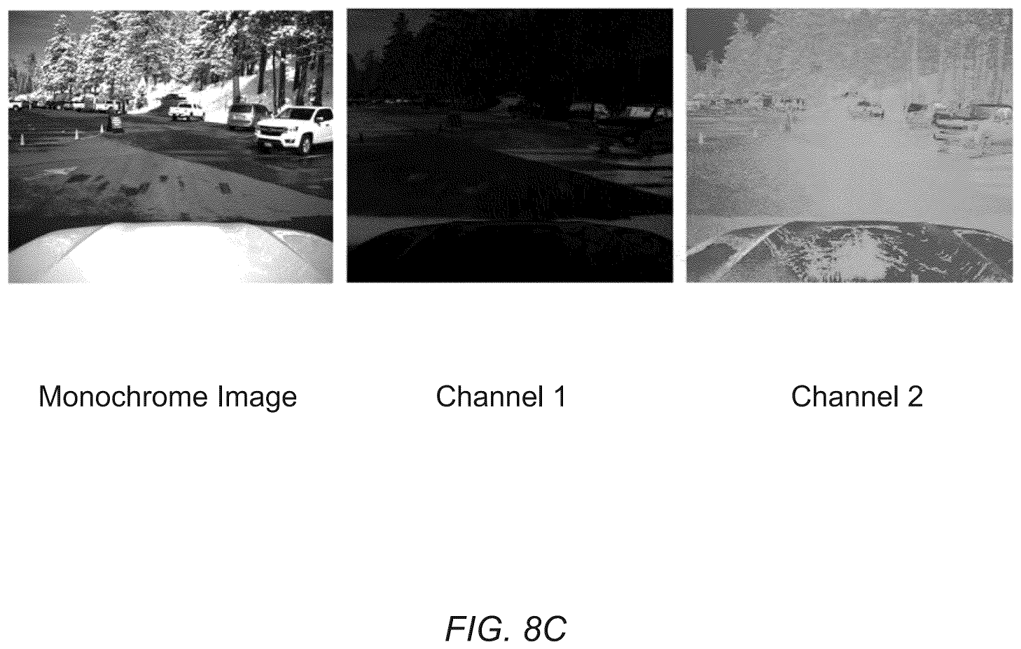

Additionally or alternatively, images generated by systems operating in accordance with various embodiments of the invention may configure one or more channels for various polarizations. These channels may (in some cases) be represented/converted to visual configurations including but not limited to greyscale and RGB. In accordance with some embodiments of the invention, a first channel may be used to optimize the identification of material properties. Additionally or alternatively, a second channel may be used to distinguish object shape and/or surface texture. This is reflected in the parking lot depicted in FIG. 8A, wherein the respective impacts of oil and water on a dry surface are emphasized. In channel 1, the brightness that the water and (especially) the oil exhibit compared to the dry surface is fairly pronounced, thereby distinguishing the two materials. Meanwhile, in channel 2, the (liquid) surface texture makes the water-covered and oil-covered areas look fairly consistent with the dry (yet flat) surface, albeit with their respective boundaries evident. As shown in the two roadside examples disclosed in FIGS. 8B and 8C, images generated using various polarizations may (additionally or alternatively) result in images with dampened reflections (e.g., in channel 1) and/or distinguishable areas with more distinct surface textures (e.g., the identifiable snow and ice in channel 2).

While specific examples of the benefits of utilizing polarization imaging systems are described herein with reference to FIGS. 5A-8C, sensor platforms in accordance with embodiments of the invention should be understood as not being limited to the use of any polarization images and/or need to not incorporate a polarization imaging system at all. Indeed, many (e.g., localization) systems operating in accordance with various embodiments of the invention utilize sensor platforms incorporating conventional cameras. Processes that can be utilized to calibrate the various sensors incorporated within a sensor platform in accordance with an embodiment of the invention are discussed further below.

### D. Sensor Calibration

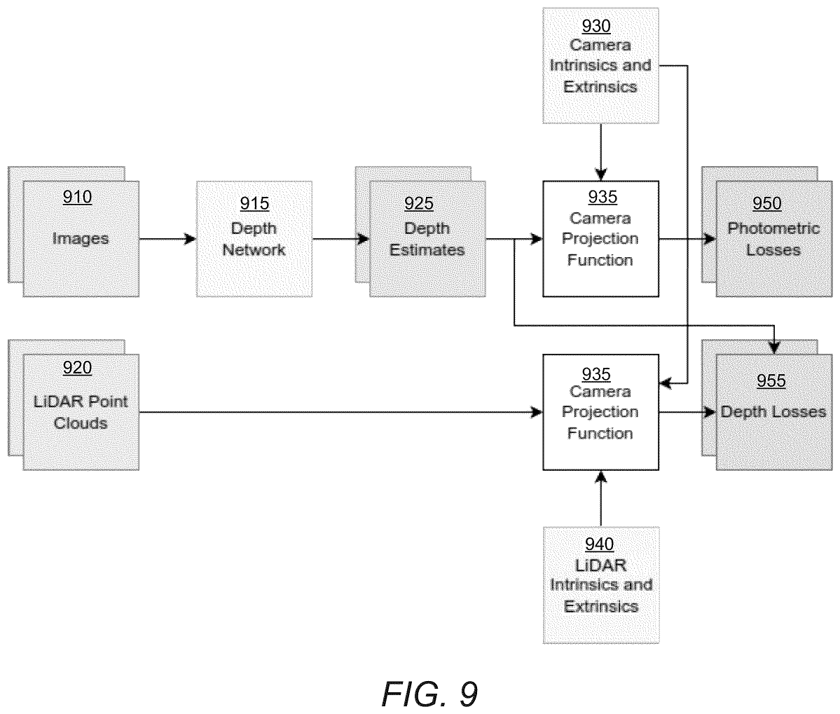

A multi-sensor calibration setup in accordance with multiple embodiments of the invention is illustrated in FIG. 9. Sensor platforms utilized within machine vision systems typically require precise calibration in order to generate reliable information including (but not limited to) depth information. In many applications, it can be crucial to characterize the internal and external characteristics of the sensor suite in use. As mentioned above, internal characteristics of the sensors are typically called intrinsics and the external characteristics of the sensors can be referred to as extrinsics. Machine vision systems and image processing methods in accordance with various embodiments of the invention enable calibration of the internal (intrinsic) and external (extrinsic) characteristics of sensors including (but not limited to) cameras and/or LiDAR 940 systems. In accordance with many embodiments of the invention, cameras may produce images 910 of an area surrounding the polarization imaging system.

Additionally or alternatively, LiDAR mechanisms may produce LiDAR point clouds 920 identifying occupied points in three-dimensional space surrounding polarization imaging systems implemented in accordance with certain embodiments of the invention. Utilizing both the images 910 and the LiDAR point clouds 920, the depth/distance of particular points may be identified by camera projection functions 935. In several embodiments, a depth (neural) network 915 that uses images and point clouds of natural scenes as input and produces depth information for pixels in one or more of the input images may be utilized to perform self-calibration of cameras and LiDAR mechanisms. In accordance with several embodiments, the depth network 915 is a deep neural network such as (but not limited to) a convolutional neural network that is trained using an appropriate supervised learning technique in which the intrinsics and extrinsics of the sensors and the weight of the deep neural network are estimated so that the depth estimates 925 produced from the depth network 915 are consistent with the captured images and/or the depth information contained within the corresponding LiDAR point clouds of the scene.

Calibration processes may implement sets of self-supervised constraints including but not limited to photometric 950 and depth 955 losses. In accordance with certain embodiments, photometric 950 losses are determined based upon observed differences between the images reprojected into the same viewpoint using features such as (but not limited to) intensity. Depth 955 losses can be determined based upon a comparison between the depth information generated by the depth network 915 and the depth information captured by the LiDAR (reprojected into the corresponding viewpoint of the depth information generated by the depth network 915). While self-supervised constraints involving photometric and depth losses are described above, any of a variety of self-supervised constraints can be utilized in the training of a neural network as appropriate to the requirements of specific applications in accordance with various embodiments of the invention.

In several embodiments, the implemented self-supervised constraints may account for known sensor intrinsics and extrinsics 930, 940 in order to estimate the unknown values, derive weights for the depth network 915, and/or provide depth estimates 925 for the pixels in the input images 910. In accordance with many embodiments, the parameters of the depth network 915 and the intrinsics and extrinsics of the cameras 930 and LiDAR extrinsics 940 may be derived through stochastic optimization processes including but not limited to Stochastic Gradient Descent and/or adaptive optimizers such as (but not limited to) an AdamW optimizer. These adaptive optimizers may be implemented within the machine vision system (e.g., within an autonomous robot) and/or utilizing a remote processing system (e.g., a cloud service). Setting reasonable weights for the depth network 915 may enable the convergence of sensor intrinsic and extrinsic unknowns to satisfactory values. In accordance with numerous embodiments, reasonable weight values may be determined through threshold values for accuracy.

Photometric loss may use known camera intrinsics and extrinsics 930, depth estimates 925, and/or input images 910 to constrain and discover appropriate values for intrinsic and extrinsic unknowns associated with the cameras. Additionally or alternatively, depth loss can use the LiDAR point clouds 920 and depth estimates 925 to constrain LiDAR intrinsics and extrinsics 940. In doing so, depth loss may further constrain the appropriate values for intrinsic and extrinsic unknowns associated with the cameras. As indicated above, optimization may occur when depth estimates 925 from the depth network 915 match the depth estimates from camera projection functions 935 within a particular threshold. In accordance with a few embodiments, the photometric loss may, additionally or alternatively, constrain LiDAR intrinsics and extrinsics 940 to allow for their unknowns to be estimated.

While specific processes for calibrating cameras and LiDAR systems within sensor platforms are described with reference to FIG. 9, any of a variety of online and/or offline calibration processes can be utilized as appropriate to the requirements of specific applications in accordance with various embodiments of the invention. Furthermore, localization systems in accordance with many embodiments of the invention can utilize a variety of sensors including cameras that capture depth cues.

While specific processes for calibrating cameras and LiDAR systems within sensor platforms are described above, any of a variety of online and/or offline calibration processes can be utilized as appropriate to the requirements of specific applications in accordance with various embodiments of the invention. Furthermore, systems in accordance with many embodiments of the invention can utilize a variety of sensors including cameras that capture depth cues. Additionally, it should be appreciated that the sensor architectures described herein can also be implemented outside the context of a polarization imaging system described above with reference to FIG. 9.

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A polarization imaging system comprising:
a camera, wherein the camera is an autofocus sensor comprising:
a main lens, wherein:
an aperture plane of the main lens is overlaid with a multiplexed polarization filter;
the multiplexed polarization filter comprises a plurality of sub-filters; and
each sub-filter of the plurality of sub-filters follows a distinct polarization angle;
a detector array, wherein the detector array comprises a plurality of sensor pixels; and
a microlens array comprising a plurality of microlenses overlaid over the detector array, wherein:
the microlens array is placed at a focal plane of the main lens; and
each microlens of the plurality of microlenses is:
unfiltered; and
configured to direct incident light to a distinct subset of the plurality of sensor pixels;
a memory, wherein the memory stores:
image data from the plurality of sensor pixels; and
instructions for processing the image data; and
a processor configured to execute the instructions to process the image data.

2. The polarization imaging system of claim 1, wherein:
processing the image data comprises deriving, from the image data, a plurality of sub-aperture images; and
each sub-aperture image of the plurality of sub-aperture images corresponds to a particular sub-filter of the plurality of sub-filters.

3. The polarization imaging system of claim 2, wherein:
the plurality of sub-aperture images comprises a plurality of polarized views of a singular perspective of a scene; and
the singular perspective is captured by the camera in a single shot.

4. The polarization imaging system of claim 3, wherein processing the image data further comprises obtaining, from the plurality of polarized views, a set of depth cues for the singular perspective.

5. The polarization imaging system of claim 4, wherein processing the image data further comprises at least one of:
deriving, from the plurality of sub-aperture images, a new depth map for the scene; or
updating, from the plurality of sub-aperture images, an existing depth map for the scene.

6. The polarization imaging system of claim 5, wherein at least one of the new depth map or the existing depth map is applied to semantic scene segmentation.

7. The polarization imaging system of claim 2, wherein the distinct subset of the plurality of sensor pixels, that each microlens of the plurality of microlenses directs incident light to, comprises a sensor pixel associated with each sub-filter of the plurality of sub-filters.

8. The polarization imaging system of claim 7, wherein the sensor pixel associated with a given sub-filter of the plurality of sub-filters is sensitive to an orientation angle of the given sub-filter.

9. The polarization imaging system of claim 7, wherein deriving, from the image data, a first sub-aperture image of the plurality of sub-aperture images comprises:
for each microlens of the plurality of microlenses, locating a corresponding sensor pixel, of the distinct subset of the plurality of sensor pixels, where the corresponding sensor pixel is associated with a first sub-filter of the plurality of sub-filters; and
digitally combining the image data of the corresponding sensor pixels associated with the first sub-filter into the first sub-aperture image.

10. The polarization imaging system of claim 9, wherein, for the first sub-aperture image, a relative position of each microlens in the microlens array is equivalent to a relative position of the corresponding sensor pixel associated with the first sub-filter in the first sub-aperture image.

11. The polarization imaging system of claim 1, wherein the main lens is a standard lens.

12. The polarization imaging system of claim 1, wherein the main lens is a specialty lens.

13. The polarization imaging system of claim 1, wherein the main lens is a lens stack comprising a plurality of lens elements.

14. The polarization imaging system of claim 1, wherein the plurality of sub-filters comprises:
a first sub-filter with a polarization orientation angle of 0°;
a second sub-filter with a polarization orientation angle of 45°;
a third sub-filter with a polarization orientation angle of 90°; and
a fourth sub-filter with a polarization orientation angle of 135°.

15. The polarization imaging system of claim 1, wherein the distinct subset of the plurality of sensor pixels follows a square grouping.

16. The polarization imaging system of claim 15, wherein the square grouping is a 2×2 configuration of sensor pixels.

17. The polarization imaging system of claim 1, wherein the autofocus sensor is a phase-detection autofocus sensor.
